(19) United States
(12) Patent Application Publication
(10) Pub. No.: US 2019/0139001 A1
(43) Pub. Date: May 9, 2019

(54) AN ONLINE SYSTEM FOR EMPLOYMENT OF TEMPORARY EMPLOYEES

(71) Applicant: SLOG PTY LTD, Melbourne, Victoria (AU)

(72) Inventor: Patrick LEONIDAS, Melbourne, Victoria (AU)

(21) Appl. No.: 16/306,061

(22) PCT Filed: Jun. 5, 2017
(86) PCT No.: PCT/AU2017/050548

§ 371 Date: Nov. 30, 2018

(30) Foreign Application Priority Data
Jun. 3, 2016 (AU) 2016902162

(51) Int. Cl. G06Q 10/10

(52) U.S. Cl. CPC G06Q 10/1053

(57) ABSTRACT

An online system for employment of temporary employees using communication systems with time and location controlled access activating the communication device according to a timer for a pre-determined limited period to receive hack communications from respective employees in a collection area in the predetermined time period only; and limiting communication of offer of employment to the first prospective employee in the received order to within the predetermined short period; wherein offer and acceptance of employment is time restricted by control of communications within a predetermined short period.

### FIELD OF THE INVENTION

The present invention relates to an online system for employment of temporary employees. In particular, the invention relates to an online system for employment of temporary employees in which there is selective pressure exerted on each of the two parties being the prospective employers and the possible employees.

The invention has been developed primarily for use in/with employment of temporary employees and will be described hereinafter with reference to this application. However, it will be appreciated that the invention is not limited to this particular field of use.

### BACKGROUND OF THE INVENTION

An online system for employment of temporary employees can be said to be in practice at present. However, the systems are ineffective and inefficient. More importantly they are not adaptive.

A general first system usually involves the system of a temporary employment agency having a plurality of people “on their books” who are available at call when a prospective employer contacts the agency. In this system, there are costs of the employee to the agency including
costs of time
ii) costs of application fees and
iii) costs of loyalty or dependence to an agency.

There are also costs between the prospective employer and the agency including:
i Agency fees;
ii) Costs of screening;
iii) Costs of time in screening;
iv) Costs of advertising to attract more people “on their books”;
v) Costs of management of listings;

A general second system comprises the general advertisement, whether in print or online, and the collection by the employee and the filtering

This system is time consuming and by the time the filtering system has occurred final employment might not, occur for weeks after initial contact. This therefore requires the employer to have a predefined plan so that they can predict that a project in 6 weeks will require a further 12 employees. This can be possible in businesses that are project managing and will be following strict plans. Other industries such as hospitals, catering firms, schools, councils, need to be on a needs basis and therefore their capabilities need to fluctuate and this requires a fluctuating workforce.

Further, even in the project managing businesses, such as industry or mining there can be a change of project requirements due to external situations such as fall of the dollar, need for increased supply due to natural disaster to competing country, industry or company, change in expected workforce due to injury, health issues or other welfare considerations. It is important for businesses to be able to cope with unexpected fluctuations in order to take advantage of situations and to be able to seal the next deal as they have been shown to be adaptive and to overcome problems.

It can be seen that the present systems have a plurality of problems including:
a) The inability to adapt in quick time;
b) The need for the prospective employee to be waiting on a list for weeks in order to be maintaining the position of being “on the books” to the employment agency;
c) The inequality of power of the prospective employer to the temporary employee;
d) The need for intermediaries and the delays in long selection processes.

The present invention seeks to provide an online system for employment of temporary employees, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, an online system for employment of temporary employees is provided by a notification to signed in parties according to one or more predefined criteria

It can be seen that the invention of an online system for employment of temporary employees provides the benefit of selection process

According to a second aspect of the present invention, an online system for employment of temporary employees is provided by both the notified party and the prospective employer have a predefined time periods to accept and confirm employment

It can be seen that the invention of an online system for employment of temporary employees provides the benefit of timing process

According to a third aspect of the present invention, there is provided an online system for employment of temporary employees is provided by the prospective employers having a duty to take the first client that funs requirements but could have a limited review or reject options over three job employment opportunities or over a time period such as a week or month.

It can be seen that the invention of an online system for employment of temporary employees provides the benefit of rejection process

In one form the invention provides an online system for employment of temporary employees including an online system for employment of temporary employees comprising a computing device; and a computer-readable storage device having a controller coupled to the computing device and having instructions stored thereon which, when executed by the computing device, cause the computing device to perform operations comprising:
determining a first prospective employer criteria requirements fora first temporary employee;
communicating a notification over a communication means of a need for temporary employees meeting the first prospective employer criteria requirements for a first temporary employee; and
receiving offer from a plurality of prospective temporary employees over communication means;
determining a temporary employee activity score for each of the plurality of prospective temporary employees, wherein a temporary employee activity score is based on the prior quality of the respective temporary employee activity recorded within the computer-implemented online system for employment service;
determining that the first user activity score exceeds a first threshold user activity score;
listing of the plurality of prospective temporary employees; and
sending completion of offer of employment with selected prospective;
   further comprising having a location device for sensing one or more location relations prospective temporary employee including Current position; Usual position; Former employment positions; Range from prospective employment;
   wherein the online system allows for ready matching and selection of employee from the listing of prospective temporary employees and direct offer and acceptance between the employer and employee;

the system further comprising: a timer, a geographical locate and a response order listing;

wherein a temporary employee meeting a minimum temporary employee activity score will be accepted if response within time and in response order unless prospective employer enacts the rejection system and
the system further comprising having: a first timed communication clock and a second timed communication clock wherein both the notified party and the prospective employer have a predefined time periods to accept and confirm employment;
and the system further comprising the rejection system having: a timer and a counter of rejections wherein prospective employers have a duty to take the first client that fulfils requirements but could have a limited review or reject options over three job employment opportunities or over a time period such as a week or month.

It can be seen the system provides a better communication system substantially assembled with improving security including any one or more of the following:
i. Improvements in structure of the interaction between employers and prospective temporary employees;
ii. Improvements in timing and control of timing of employer and prospective employees
iii. Improvements in efficiency of selection process by automatic qualification process,
iv. Improvements by the streamlining and direct communication between the employers and prospective temporary employees.

The invention also provides an online system for employment of temporary employees wherein the system further comprising: a timer counting down providing a prospective employee response time from a time of communication of employment offer; a geographical locater providing a limited pre-assessed collection area at a relative location to the prospective employer; and a response order listing providing a fixed collection of prospective employees responding communication; wherein a temporary employee meeting a minimum temporary employee activity score is accepted if response within time and in response order unless prospective employer enacts the rejection system.

The invention provides an apparatus for employment of temporary employees. comprising:
at least one memory including computer program code; and
at least one processor having a controller and a plurality of modules,
at least a location limiter for automatically limiting the communication to prospective employees that meet a location limiting collection area under a predetermined requirement of the prospective employer;
at least a first clock and a second clock
   wherein the assessing one or more employment opportunities of the prospective employees is with regard to the one or more criteria of relative geographical location to the prospective employer to define a collection area,
   and wherein the first and second clocks provide control timing of communication between the prospective employer and the prospective employees in the collection area wherein there is automatically communicating at a communication time with an offer to a prospective employee who has been pre-assessed to be relevant and meeting the one or more criteria of relative geographical location to the prospective employer to be in the collection area; such that the offer and acceptance of employment is time restricted by control of communications to a predetermined short period.

A method for employment recruiting is provided by the invention with the method comprising:
listing temporary prospective employees in a user list table as being relevant to a prospective employer,
assessing one or more employment opportunities of the prospective employees is with regard to the one or more criteria of relative geographical location to the prospective employer to define a collection area and
automatically communicating at a communication time with an offer to a prospective employee who has been pre-assessed to be relevant and meeting the one or more criteria of relative geographical location to the prospective employer to be in the collection area;
activating the communication device according to a timer for a predetermined limited period to receive back communications from respective employees in that collection area in the predetermined time period only;
providing the received communications in received order and
presenting the received communications in the received order;
and providing a countdown timer defining a predetermined short period from the communication time; and
limiting communication of offer of employment to the first prospective employee in the received order to within the predetermined short period;
   wherein offer and acceptance of employment is time restricted by control of communications to a predetermined short period,

A computer program product embodied on a non-transitory computer readable storage medium for employment of temporary employees, has the computer program product being encoded with instructions to control a processor to perform a process, the process comprising:
listing temporary prospective employees in a user list table as being relevant o a prospective employer,
assessing one or more employment opportunities of the prospective employees is with regard to the one or more criteria of relative geographical location to the prospective employer to define a collection area, and
automatically communicating at a communication time with an offer to a prospective employee who has been pre-assessed to be relevant and meeting the one or more criteria of relative geographical location to the prospective employer to be in the collection area;
activating the communication device according to a timer for a predetermined limited to period to receive back communications from respective employees in that collection area in the predetermined time period only;
providing the received communications in received order and
presenting the received communications in the received order;
and providing a countdown timer defining a predetermined short period from the communication time; and
limiting communication of offer of employment to the fret prospective employee n the received order to within the predetermined short period;
   wherein offer and acceptance of employment is time r rioted by control of communications to a predetermined short period;
   wherein the computer program product connects with and receives data from
a) a timer
b) a geographical locater, and
c) a response order listing;
   and wherein computer program controls a rejection system a temporary employee meeting a minimum temporary employee activity score will be accepted if response within time and in response order unless prospective employer enacts the rejection system.
   In a related aspect of the present invention there is disclosed an online system for employment of temporary employees comprising: a computing device; and a computer-readable storage device having a controller coupled to the computing device and having instructions stored thereon which, when executed by the computing device, cause the computing device to perform operations comprising: determining a first prospective employer criteria requirements for a first temporary employee; communicating a notification over a communication means of a need for temporary employees meeting the first prospective employer criteria requirements for a first temporary employee: determining a temporary employee activity score for each of the plurality of prospective temporary employees, wherein a temporary employee activity score is based on the prior quality of the respective temporary employee activity recorded within the computer-implemented online system for employment service: determining that the first user activity score exceeds a first threshold user activity score; and receiving offer from a plurality of prospective temporary employees over communication means, a geographical locater providing a limited pre-assessed collection area at a relative location to the prospective employer: listing of the plurality of prospective temporary employees; and wherein the online system automatically matches selection of prospective employees from the listing of prospective temporary employees that have been pre-assessed in the collection area and allows direct offer and acceptance between the employer and employee: and further comprising: a first timed communication clock triggered by the sent offers and operable for a predetermined period to receive response from one or more of selected prospective employees within the predetermined first timed communication clock, determining order of employee responses and acceptances for sequential review by the employer, a second timed communication clock for employer to open employee profiles in order of the employee responses received in the first timed communication clock, determining successful employee within the second timed communication clock and confirming a job offer to successful employee, a third timed communication clock triggered by sent job offer operable for a further determined time for the successful employee to accept the iota offer from employer within the further predetermined time, wherein both the notified party and the prospective employer have an automatic countdown timer controlling communications between prospective employer and prospective employees creating an automatically controlled predefined time periods to accept and confirm employment, and wherein the third timer clock directs the employer to the second timer clock for review and consideration of a second of the listed employees if the first successful employee declines or no response is received from the first successful candidate within the predetermined third timer clock.

Preferably during the second timed communication clock the controller allows access of employer to employee responses in order of response received so as to control assessment of prospective employees in order of employee response received within the first timed communication clock, and wherein a second and subsequent received employee response is accessible once previous prospective employee candidate has been assessed.

Preferably the online system further comprises communication means including a video link or a messenger link wherein during the second timed communication clock the employer is able to conduct an interview with the prospective employee.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic flow diagram of a general process of one aspect of an online system for employment of temporary employees in accordance with a preferred embodiment of the present invention;

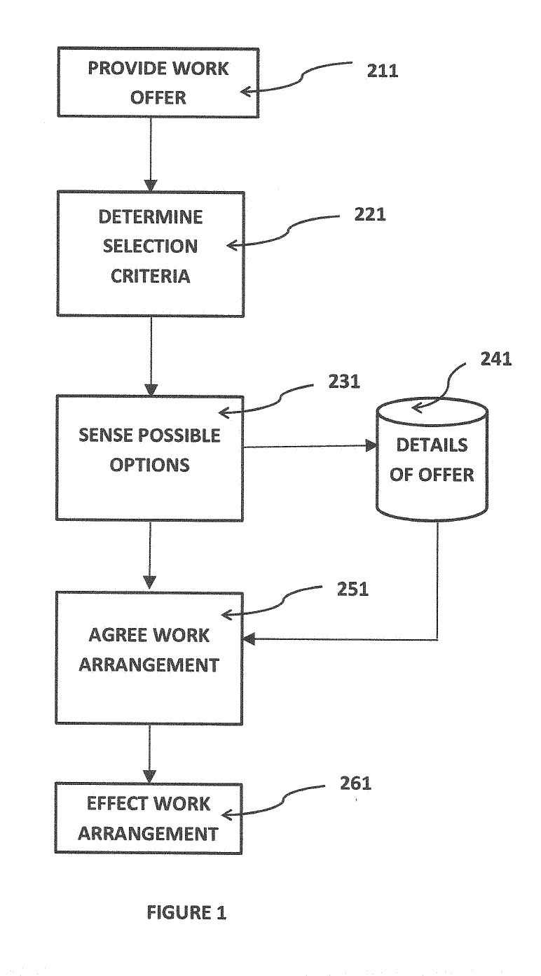

FIG. 2 is a diagrammatic view of a criteria of geographical location for automatic detection so as to determine automatic meeting of this selection criteria in accordance with a preferred embodiment of the present invention.

FIG. 3 is a tabular variation of geographical criteria in which automatic recordal of previously worked in location or preferred location for automatic detection so as to determine automatic meeting of this selection criteria in accordance with a preferred embodiment of the present invention.

FIG. 4 is a diagrammatic view of a system of apparatuses including telecommunication systems in order to control the timing range of communication and the localization range of communication for use in effecting the automatic meeting of this selection criteria in accordance with a preferred embodiment of the present invention of FIG. 2;

FIG. 5 is a diagrammatic flow diagram of an overall process of communication and automatic interaction in an online system for employment of temporary employees n accordance with a preferred embodiment of the present invention;

FIG. 6 is a diagrammatic flaw diagram of a control of rejection process of one aspect of an online system for employment of temporary employees in accordance with a preferred embodiment of the present invention;

FIG. 7 is a diagrammatic flow diagram of an overall process of communication and automatic interaction in an online system for employment of temporary employees in accordance with a preferred embodiment of the present invention.

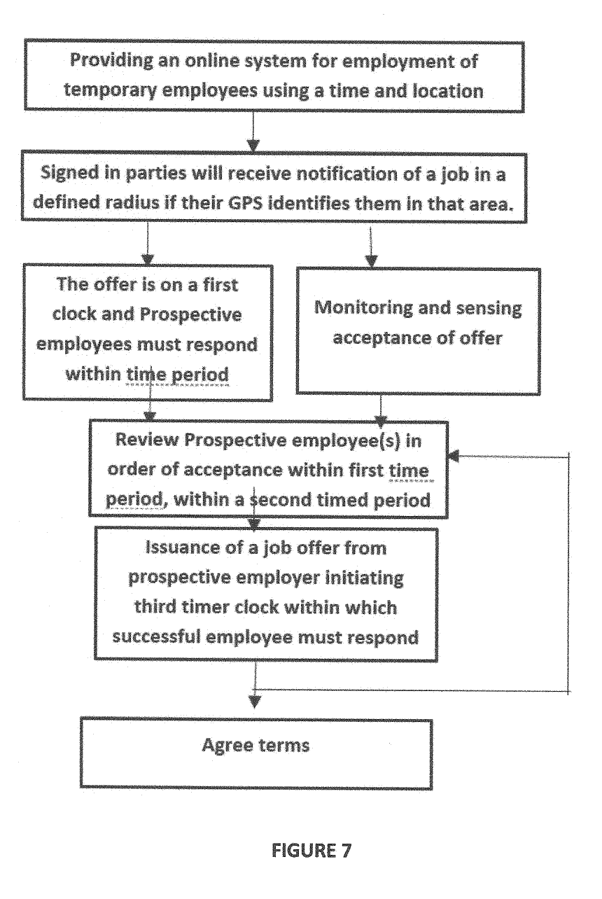

### DESCRIPTION OF PREFERRED EMBODIMENTS

It should be noted in the following description that like or the same reference numerals in different embodiments denote the same or similar features.

Referring to the drawings there is the particular a computing device; and
a) a computer-readable storage device having a controller coupled to the computing device and having instructions stored thereon which, when executed by the computing device, cause the computing device to perform operations comprising:
b) determining a first prospective employer criteria requirements for a first temporary employee;
c) communicating a notification over a communication means of a need for temporary employees meeting the first, prospective employer criteria requirements for a first temporary employee; and
d) receiving offer from a plurality of prospective temporary employees over communication means;
e) determining a temporary employee activity score for each of the plurality of prospective temporary employees, wherein a temporary employee activity score is based on the prior quality of the respective temporary employee activity recorded within the computer-implemented online system for employment service;
f) determining that the first user activity score exceeds a first threshold user activity score;
g) listing of the plurality of prospective temporary employees: and
h) sending completion of offer of employment with selected prospective employees;

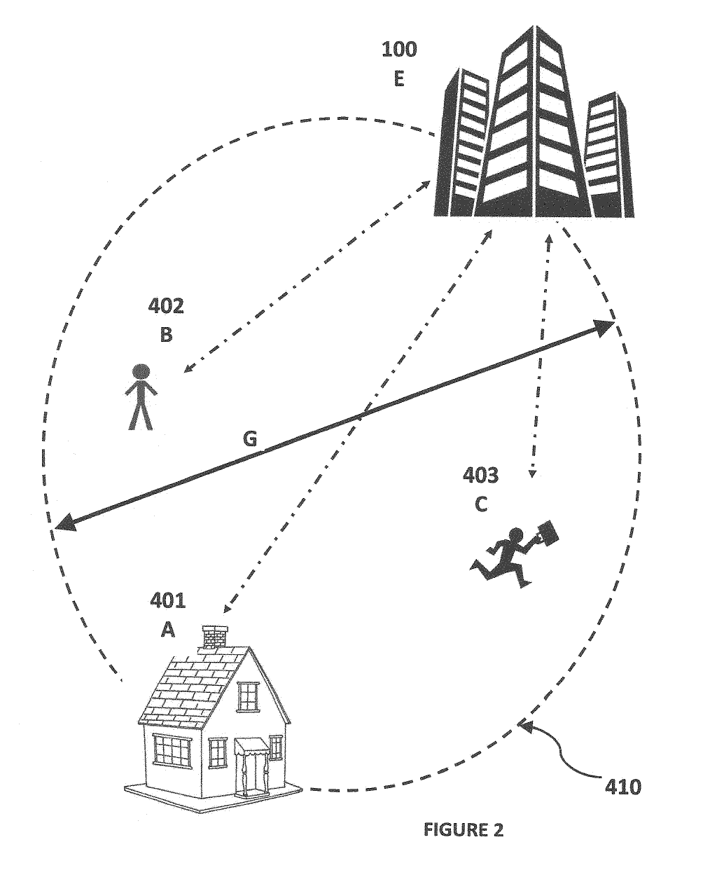

Referring to FIGS. 2, 3 and 4, there is a need by a first employer 100 at E to have an employee with certain requirements. That user 100 wishes to have employees A, B or C that are housed in the area 410, or are presently located in the area or are passing through the area. To make use of the location limitation there is a limitation of possible employees by first determining if the prospective employees fulfil the location requirement as defined in this case by a range G forming a collection area 410, It is to these parties A, B and C that the telecommunication from E occurs by the telecommunication 100 of E communicating to the communication devices 401, 402 and 403 of A, B and C respectively.

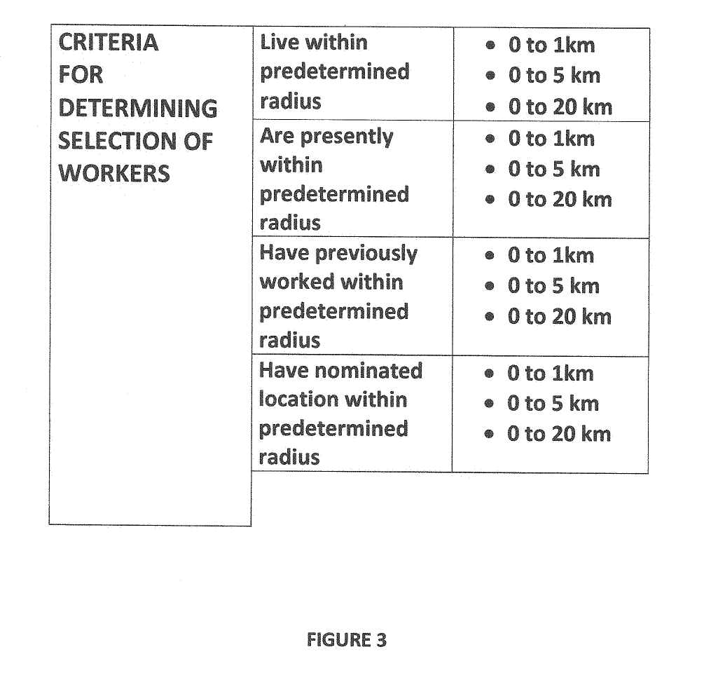

FIG. 3 details options of criteria for determining selection of workers so that there is a more effective relationship of the location defining collection area 410 and the Employee E.

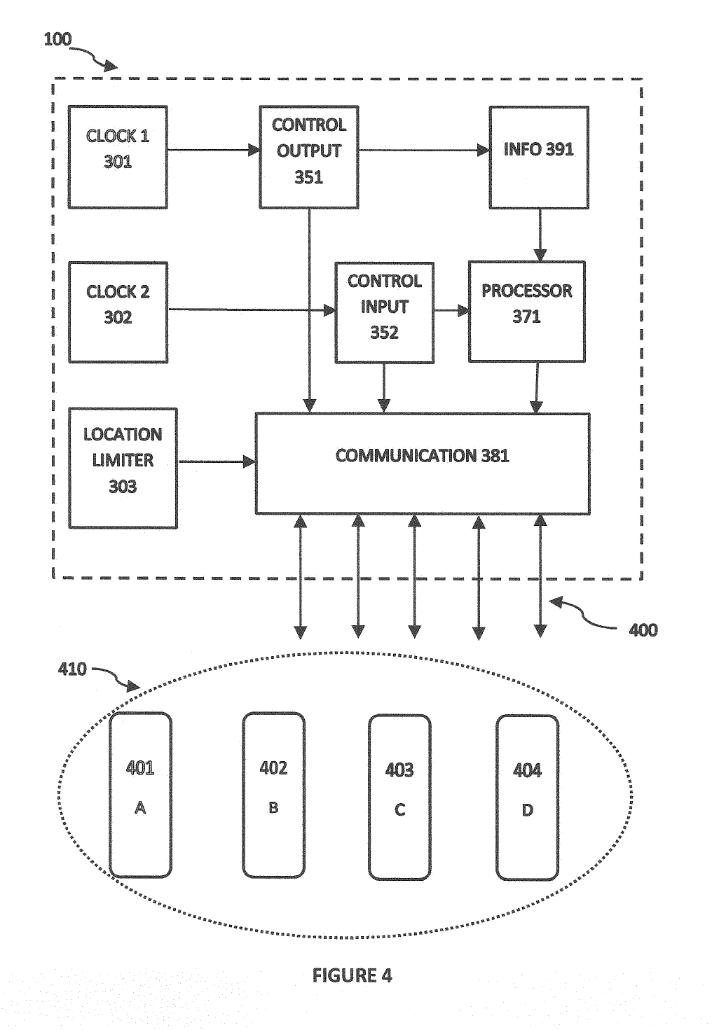

Referring to FIG. 4 there is shown a telecommunication system which could be a computerised online system 100 of a first employer E and the timing constraints on the employers E and prospective employees A, B or C to give a fairer and more effective selection process and a more time efficient and more data manipulation efficiency due to predefining of possible employees.

As shown the employee communication device 100 of employer E or the online system that the employer E accesses has a first clock 301 so as to control the output communication of the employer E. The system further includes a second clock for controlling the time that the communications 400 can be received from the prospective employees A, B, C or D from their telecommunication devices 401, 402, 403 and 403 respectively as they all qualify within the range collection area 410.

The location limiter of the system according to FIGS. 2 and 3 is further provided by system including the location limiter 303 that determines and preassesses the possible employees A, B, C within the defined collection area 410.

It can be seen that the clock 1 301, clock 2 302 and location limiter 303 effectively change the operational communication of the It does not provide an option but controls when, how and where the communication occurs to provide an automatic control over the actions of the prospective Employer E and the prospective Employees A, B C and D.

### Selection Process

Referring to the drawings there is shown an operations in Figure the system comprises using and automatically controlling by:
a. a timer
b. a geographical locater; and
c. a response order listing;
   wherein a temporary employee meeting a minimum temporary employee activity score will be accepted if response within time and in response order unless prospective employer enacts the rejection system.

A benefit of having a timer geographical locater and response order listing is that there is an element of automation and quickness vin the selection process. The selection is not reliant on subjective review which can be a long process, and can be a prejudicial process and in essence an unfair or unpredictable process that results in not the “next” person getting the job if they are appropriate. By this process the possible employees are given a better opportunity of knowing outcome rather than believing it is a lottery based on the whim of the employer.

Another substantial benefit of this process of selection is that the process is very quick. In this way the employer and employee can finalise the employment contract in the morning and have the person working that day and the person, being automatically paid.

### Timing Process

The system further comprises having:
a) a first timed communication clock
b) a second timed communication clock
   wherein both the notified party and the prospective employer have a predefined time periods to accept and confirm employment,

The system further fast tracks the process by having a clock not only on the prospective employee but also a clock on the employer. This guarantees that there is equal pressure on both of the parties to fulfil their requirements rather than the usual power going totally to the employer, and the prospective employees having to wait around all day or all week to see if they are successful in obtaining the job,

The system further comprises a third timed communication lock which is triggered by sent job offer operable for a further predetermined time for the successful employee to accept the job offer from employer within the further predetermined time, wherein both the notified party and the prospective employer have an automatic countdown timer controlling communications between prospective employer and prospective employees creating an automatically controlled predefined time periods lo accept and confirm employment, and wherein the third timer clock directs the employer to the second timer clock for review and consideration of a second of the listed employees if the first successful employee declines or no response is received from the first successful candidate within the predetermined third timer clock.

### Rejection Process

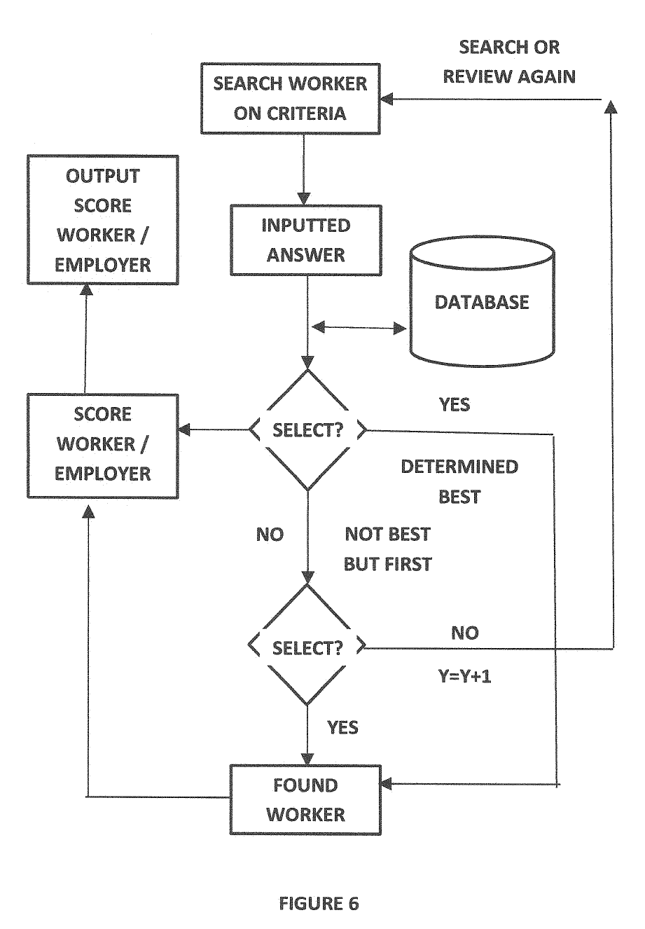

In still another form the invention includes prospective employers have a duty to take the first client that fulfils requirements but could have a limited review or reject options over three job employment opportunities or over a time period such as a week or month. This can be achieved as shown in FIG. 6 in which the system further comprising the rejection system having:
a) a timer;
b) a counter of rejections
   wherein prospective employers have a duty to take the first client that fulfils requirements but could have a limited review or reject options over three job employment opportunities or over a time period such as a week or month.

The system further fast tracks the process by not allowing rejections without consequences. Therefore, the prospective employer only has a given number of rejections in a certain time and therefore cannot convert the system back to a slow employer favoured system. Instead the automatic control and selection means that the next who is appropriate is the one. However clearly sometimes the employer wishes to have some selection element. It is therefore limited by a limited number of rejections and automatic progress down the list.

To further maintain the effectiveness and fairness of the rejection system beyond the limited number of rejections there can be a rating system which rates the employer by the number of rejections so that the prospective employee have an immediate indication of the style and likelihood of being first in and therefore first to be offered the job.

### Example 1

Referring to the drawings there is shown in FIGS. 2 and 4 the system used by an employer E wishing to obtain temporary employees to fill in for the day due to the some of the usual workforce being ill or due to the workload of that day requiring more than the usual personnel. The employer E then transmits an offer O making use of:
a timer and
a geographical locater;
meeting criteria

Generally, a temporary employee meeting a minimum temporary employee activity score will be accepted if response within time and in response order unless prospective employer enacts the rejection system.

Therefore, the steps that have been taken are:
determining a first prospective employer criteria requirements for a first temporary employee;
communicating a notification over a communication means of a need for temporary employees meeting the first prospective employer criteria requirements for a first temporary employee; and
receiving offer from a plurality of prospective temporary employees over communication means;

The Negotiation is clearly under the pressure both sides of a Timing Process. The employer has sent an offer O to be received by anyone in the geographical limitation of area with circumference G. The timing of this offer O system further comprises having:
a) a first timed communication dock
b) a second timed communication dock

Both the notified party and the prospective employer have a predefined time periods to accept and confirm employment. In particular the Employer E could send the offer O at 9.00 am which starts the first timed communication dock and responses R to the offer O will only be accepted if within that period. That period could be 20 minutes i.e. 9.00am to 9.20 am. The great benefit of this system is that the prospective employees A, B, or C can be waiting for employment offers over a precise period.

A response order listing can be made of the order of response. So that applicant A could have responded first at 9.02 am while applicant C could have responded second at 9.08 while the third applicant to respond at 9.17 was applicant B. Therefore, the response order listing comprises:

A
C
B

An important aspect is that there is automatic filtering by the three criteria of geography, timing and fulfilling minimum criteria needed for the job that only A, B and C needs to be considered. This minimises wasted time in reviewing a multitude of prospective employees over an extended time. The applicant D might have been a great possibility yesterday but since did not respond today within time and within geographic limits is not eligible today. This means the applicant D might have a job elsewhere or not be available, This eliminates unnecessary reviews and negotiations.

The next important element is that the employer E has pressure on them in the decision process as the second timed communication dock could start at 9.20 am and extend to 9.40 am in which time the offer and employment must be completed.

This can include the steps of:
determining a temporary employee activity score for each of the plurality of prospective temporary employees, wherein a temporary employee activity score is based on the prior quality of the respective temporary employee activity recorded within the computer-implemented online system for employment service;
determining that the first user activity score exceeds a first threshold user activity score;
listing of the plurality of prospective temporary employees; and
sending completion of offer of employment with selected prospective employee/applicant.

### Example 2

In this example, it is similar to Example 1 but instead of the Employer E transmitting an offer the prospective employees A, B and C transmit an availability which the Employer E can view and see if falls within the required geographic area and within the right timing and with the right criteria

Therefore, in this example the response order listing is created by the timing order of when the applicants entered their details in the system. This could result in the initial list comprising:

A
C
B
D
E

However, this is still filtered by the primary filtering of criteria on the day of
a) a timer and
b) a geographical locate.;
c) meeting criteria

The timer could be the receipt of employee interest between 9.00 am and 9.20 am on the day.

Therefore, the list is filtered using the update response time to form the immediate response order listing of:

A
C
B

The Employer E then proceeds through the steps of negotiation while the second timed communication clock is on the Employer E to reach the sending completion of offer of employment with selected prospective employee/applicant. Therefore, the employer still must undertake an offer within the required time such as 9.20 am to 9.40 am.

### Example 3

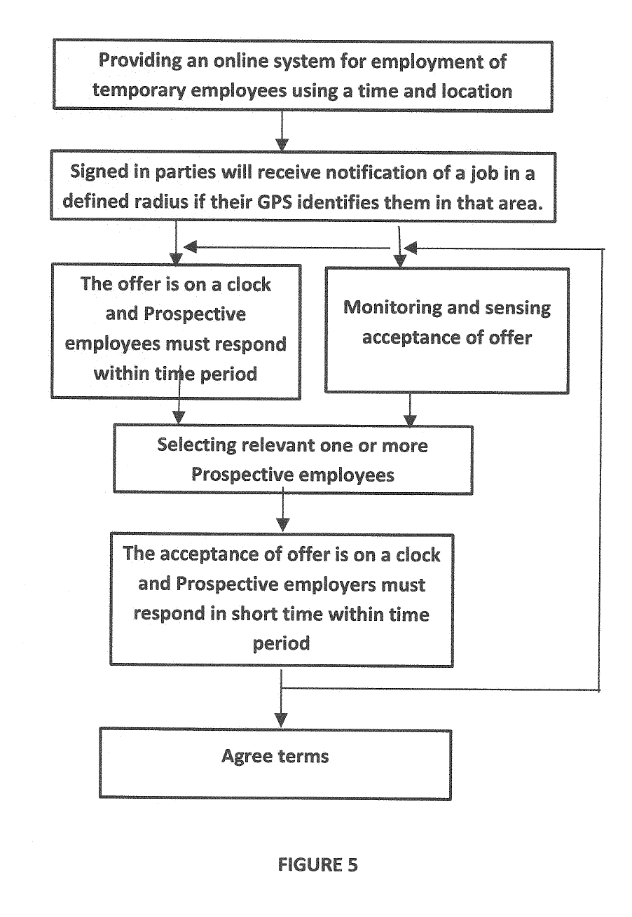

In either of examples 1 or 2 then can also be included a Rejection Process in which the prospective employer E has a duty to take the first client that fulfils requirements but could have a limited review or reject options over three job employment opportunities or over a time period such as a week or month, This can be achieved as shown in FIG. 5; in in which the system further comprising the rejection system having:
i) a timer;
ii) a counter of rejections

Prospective employers have a duty to take the first client that fulfils to requirements but could have a limited review or reject options over three job employment opportunities or over a time period such as a week or month.

A
C
B

The Employer E can determine to not have A due to being a residence or because the applicant appears to be inappropriate. The Employer E can then use a first rejection and proceed to finalise Offer with next on list being C.

It is important in order to meet the fast turnaround that rejections are minimised. In this way the system is fair and pressure due to the clocks on both the Employer E and applicants A, B and C lend to a fast turnaround achieved by the combination of the required geographic area and within the right timing and with the right criteria.

### Variations

There can also be variations to the system such as:
a) Drop down menu for selection criteria of prospective employees
b) Drop down menu of expertise for prospective employees to detail their initial criteria
c) Drop down menu of details of the actual job in detail so that automatically match criteria of needs with prospective employee expertise.

There can also be variations to the system such as:
a) Details of personality profile and representations diagrammatically
b) Coding such as colour coding to show closeness of automatic matching of criteria of needs with prospective employee expertise
c) Other visual aids to speed process so that the prospective employee can pre-complete or respond in the time allowed
d) Other visual aids to speed process so that the employer can pre-complete or select and respond in the time allowed,
e) Automation of contract and personal detail collection and wage payments.

### INTERPRETATION

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, wee-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim, all such changes and modifications as fail within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Industrial Applicability

It is apparent from the above, that the arrangements described are applicable to the employment, service and recruitment industries.

1. An online system for employment of temporary employees comprising
a) a computing device; and
b) a computer-readable storage device having a controller coupled to the computing device and having instructions stored thereon which, when executed by the computing device, cause the computing device to perform operations comprising:
c) determining a first prospective employer criteria requirements for a first temporary employee;
d) communicating a notification over a communication means of a need for temporary employees meeting the first prospective employer criteria requirements for a first temporary employee; and
e) receiving offer from a plurality prospective temporary employees over communication means;
a location device for sensing or pre-assessing one or more location relations between the prospective employee with the prospective temporary employees comprising one or more of:
i) Current position;
ii) Usual position;
iii) Former employment positions;
iv) Location range from prospective employer;
g) listing of the plurality of prospective temporary employees: and
wherein the online system automatically matches selection of prospective employees from the listing of prospective temporary employees that have been pre-assessed in the collection area and allows direct offer and acceptance between the employer and employee; and further comprising:
a first timed communication clock
a second timed communication clock
wherein both the notified party and the prospective employer have an automatic countdown timer controlling communications between prospective employer and prospective employees creating, an automatically controlled predefined time periods to accept and confirm employment.

2. An online system for employment of temporary employees according to claim 1 further comprising:
a) determining a temporary employee activity score for each of the plurality of prospective temporary employees, wherein a temporary employee activity score is based on the prior duality of the respective temporary employee activity recorded within the computer-implemented online system for employment service;
b) determining that the first user activity score exceeds a first threshold user activity score.

3. canceled

4. canceled

5. An online system for employment of temporary employees according to claim 1 further comprising the rejection system having:
a) a timer;
b) a counter of rejections
wherein prospective employers are provided with the first client that fulfils requirements.

6. An online system for employment of temporary employees according to claims 1, wherein prospective employers have a counter counting down from a maximum set number such as three matching a limited review or reject options over three job employment opportunities over a time period such as a week or month.

7. An online system for employment of temporary employees according to claims 1, wherein the system further comprising:
a. a timer counting down providing a prospective employee response time from a time of communication of employment offer
b. a geographical locater providing a limited pre-assessed collection area at a relative location to the prospective employer; and
c. a response order listing providing a fixed collection of prospective employees responding communication;
wherein a temporary employee meeting a minimum temporary employee activity score is accepted if response within time and in response order unless prospective employer enacts the rejection system.

8. (canceled)

9. (canceled)

10. (canceled)

11. (canceled)

12. An online system for employment of temporary employees according to claim 1, further comprising a third timed communication clock triggered by a sent job offer operable for a further predetermined time for the successful employee to accept the lob offer from employer within a further predetermined time, wherein both the notified party and the prospective employer have an automatic countdown timer controlling communications between prospective employer and prospective employees creating an automatically controlled predefined time periods to accept and confirm employment, and wherein the third timer dock directs the employer to the second timer clock for review and consideration of a second of the listed employees if the first successful employee declines or no response is received from the first successful candidate within the predetermined third timer clock.

13. An online system for employment of temporary employees comprising::
a computing device; and
a computer-readable storage device having a controller coupled to the computing device and having instructions stored thereon which, when executed by the computing device, cause the computing device to perform operations comprising:
determining a first prospective employer criteria requirements for a first temporary employee:
communicating a notification over a communication means of a need for temporary employees meeting the first prospective employer criteria requirements for a first temporary employee;
determining a temporary employee activity score for each of the plurality of prospective temporary employees, wherein a temporary employee activity score is based on the prior quality of the respective temporary employee activity recorded within the computer implemented online system for employment service;
determining that the first user activity score exceeds a first threshold user activity score; and
receiving offer from a plurality of prospective temporary employees over communication means;
a geographical locater providing a limited pre-assessed collection area ate relative location to the prospective employer;
listing of the plurality of prospective temporary employees; and
wherein the online system automatically matches selection of prospective employees from the listing of prospective temporary employees that have been pre-assessed in the collection area and allows direct offer and acceptance between the employer and employee; and further comprising:
a first timed communication clock triggered by the sent offers and operable for a predetermined period to receive response from one or more of selected prospective employees within the predetermined first timed communication clock
determining order of employee responses and acceptances for sequential review by the employer,
a second timed communication clock for employer to open employee profiles in order of the employee responses received in the first timed communication clock
determining successful employee within the second timed communication crack and confirming a job offer to successful employee.
a third timed communication clock triggered by sent job offer operable for a further predetermined time for the successful employee to accept the lob offer from employer within the further predetermined time,
wherein both the notified party and the prospective employer have an automatic countdown timer controlling communications between prospective employer and prospective employees creating an automatically controlled predefined time periods to accept and confirm employment, and wherein the third timer clock directs the employer to the second timer clock for review and consideration of a second of the listed employees if the first successful employee declines or no response is received from the first successful candidate within the predetermined third timer clock.

14. An online system for employment of temporary employees according to claim 13, wherein during the second timed communication clock the controller allows access of employer to employee responses in order of response received so as to control assessment of prospective employees in order of employee response received within the first timed communication clock, and wherein a second and subsequent received employee response is accessible once previous prospective employee candidate has been assessed.

15. An online system for employment of temporary employees according to any one of claim 13, further comprising communication means including a video link or a messenger link wherein during the second timed communication clock the employer is able to conduct an interview with the prospective employee.

16. An online system for employment of temporary employees according to claim 13, wherein employee criteria is accessible by an employee to allow updating of employee data including experience, qualifications, work timing, pay requirements and the like.
